(19) United States
(12) Patent Application Publication
(10) Pub. No.: US 2017/0246521 A1
(43) Pub. Date: Aug. 31, 2017

(54) SPORT SENSING SYSTEM

(71) Applicants: Jules Anthony deGreef, Draper, UT (US); David B. Beck, Draper, UT (US)

(72) Inventors: Jules Anthony deGreef, Draper, UT (US); David B. Beck, Draper, UT (US)

(21) Appl. No.: 15/516,877

(22) PCT Filed: Sep. 30, 2015
(86) PCT No.: PCT/US15/53285

§ 371 Date: Apr. 4, 2017

Related U.S. Application Data
(60) Provisional application No. 62/059,883, filed on Oct. 4, 2014.

(51) Int. Cl. A63B 60/46; A43B 5/00; A43B 3/00; A63B 71/06; A63B 69/38; G01L 5/00; A63C 1/00; A63B 59/70; A63B 59/00; A63B 24/00; G01L 1/20; A63B 69/36; A63B 69/00

(52) U.S. Cl. CPC A63B 60/46; A63B 69/3667; A43B 5/00; A43B 3/0005; A63B 71/0622; A63B 69/38; A63B 69/0024; A63B 69/0026; A63C 1/00; A63B 59/70; A63B 59/00; A63B 24/0006; G01L 1/205; G01L 5/0052; A63B 2069/367; A63B 2220/833; A63B 2220/40; A63B 2102/32

(57) ABSTRACT

A system has footwear and a striking device. The striking device has a shaft connected to a striking surface for contacting an object. A sensor affixed to the shaft changes electrical resistance when the striking surface is swung to contact the object to in turn generate a signal reflective of the deflection of the shaft. The footwear is configured with an array of sensors that change at least one electrical characteristic upon deflection when the player is operating the striking device. The footwear is to send signals reflective of the deflection of the feet as the shaft is swung. The signals reflective of the deflection of the shaft and the footwear are sent to a cell phone, notebook, PC or the like suitably programmed to present audio and visual images of the feet positions and movement and movement of the striking device (e.g., golf club, racket).

A system is disclosed for use with a player of a sport which system has footwear on the player's feet and a striking device for grasping in at least one hand. The striking device has a shaft connected to a surface for contacting an object wherein the striking device includes a shaft with a sensor affixed to the shaft which sensor changes at least one electrical characteristic upon deflection of the shaft when the shaft is operated by the player in a manner to contact the object with a striking surface and upon application of an electrical power to generate a signal reflective of the deflection of the shaft upon its operation by the player to strike the object. The footwear is configured with an array of sensors of the type that change at least one electrical characteristic upon deflection when the player is operating the striking device which sensors are positioned in or as part of the footwear. Both the footwear and the striking device are configured to generate and transmit signals reflective of the deflection of the feet as the player is manipulating the shaft and signals reflective of the deflection of the shaft all to a remote location which signals are processed and presented for visual observation by another.

In sports, coaches (includes assistant coaches, teachers, assistants, instructors, trainers and others advising, directing or assisting players) from time to time or on occasion may seek to instruct or advise the player in connection with the player's performance. That is, the coach will seek to instruct the player on preferred or recommended ways to stand or otherwise to position his or her weight on his or her feet (i.e., the player's stance) and on ways to strike an object with a striking device when in the stance.

When standing upright, a human is typically supported by or deemed to be standing on his or her two feet. (In some cases a person may be standing on one or two prostheses in lieu of legs/feet. Thus the term “feet” or “foot” is intended to include prosthetic as well as natural feet/foot) It is generally accepted that each foot has three areas of support, namely the heel, the ball (behind the big toe) and the outside (behind the little toe). It is also known that many people have legs of different length and feet of different size. In turn, the weight of an upright person may not be evenly distributed between left and right legs and/or, in turn, between left and right feet. In addition, the feet of a player may be oriented so that the three areas of support are not in a plane. In turn, the weight of the player is borne unevenly between the three points of support. Thus learning how a player is standing and positioning his or her weight while moving is something that is not self evident.

For sports involving the use of a striking device (e.g., golf, tennis, badminton, squash, racket ball, ice hockey, field hockey, jai alai, baseball, cricket), the coaches also may from time to time and/or on occasion not only want to observe and then instruct on stance and movement of feet and movement of body weight, but also instruct the player on ways to move or manipulate the striking devices separately and in coordination with the feet to hit an object (e.g., golf ball, tennis ball, squash bail, shuttlecock, racket ball, puck, ball, pelota) to obtain desired results such as increased distance, spin, azimuth, flight path and the like.

Various photographic and video image technologies have been used to observe the player at rest and in motion moving his or her feet and moving a striking device. For example, cameras are now used to observe and measure the speed of a golf club impacting a ball and the ball speed and spin while the player is being videotaped to show body movements including leg and arm movements. Coaches or instructors will observe the results of the video imaging and advise or direct the player to adjust or maintain feet position and weight shift while moving the body to secure a desired ball flight. Of course, videotaping is a well known tool to observe the performance of a player performing a sport as the tape or image can be slowed (slow motion) and even stopped in some cases to study and show movements that the coaches wish to enhance or adjust as the case may be.

However there are no low cost and portable systems and systems that are mobile with the player known to measure and visually display to a coach or other player on site or nearby, the weight allocation between feet of a player at rest and in motion and also at the same time measure the movement of a striking device by that player from a rest position to the striking position.

A system for use with a player of a sport in which an object is struck with a striking structure includes a striking device and footwear. The striking device is configured for grasping by the player. The striking device includes a shaft having a length with a striking structure affixed at a first end of the shaft. The striking structure is configured for striking the object while the shaft deflects by moving from a first orientation to a second orientation upon striking the object.

At least one striking sensor is attached to the shaft and positioned to sense the deflection of the shaft. The sensor is configured and positioned to change at least one electrical characteristic reflective of the amount of deflection and to supply a striking signal reflective of the amount of the deflection upon application of electrical power to the sensor. A striking processor is configured to receive the striking signal, to process the striking signal into a form for transmission to a remote receiver and a striking transmitter for transmitting the striking signal to a remote receiver.

The system also includes footwear configured for the sport and sized to fit on a foot of the player. The footwear has a support surface upon which the foot of the player is positioned to support at least part of the weight of the player and deflect upon movement of a player's foot while striking the object with the striking structure. A first footwear sensor is positioned in or proximate the support surface to sense the deflection of the support surface by the player's foot. The first footwear sensor is configured to change at least one electrical characteristic reflective of the amount of deflection and to supply a first foot signal reflective of the deflection of the support surface by the player's foot upon application of electrical power to the sensor. A footwear processor is included in the footwear and configured to receive the foot deflection signal, to process the foot deflection signal into a form for transmission to a remote receiver and a footwear transmitter for transmitting the foot deflection signal to a remote receiver.

The system also includes a receiver positioned remote from said footwear transmitter and said striking transmitter. The receiver is configured to receive the foot deflection signal and the striking signal and is also configured to form and display a visual image of the foot deflection signal and of the striking signal. It may also present an audio signal.

In a preferred arrangement the system also includes an accelerometer positioned proximate one end of the shaft of the striking device. The accelerometer is connected to the striking transmitter and configured to supply acceleration signals reflective of the acceleration of said accelerometer to the striking transmitter upon movement of the shaft from the first orientation to the second orientation. The receiver receives the acceleration signals which are processed and visually displayed.

In other embodiments, the footwear includes a second footwear sensor positioned in and proximate the support surface and spaced from the first footwear sensor to sense the deflection of the support surface by the player's foot. The second footwear sensor is also configured to change at least one electrical characteristic reflective of the amount or degree of deflection and to supply a second foot signal reflective of the deflection of the support surface by the player's foot upon application of electrical power to said sensor. The second foot signal is supplied to the foot footwear processor where it is converted to a form for further transmission to the receiver.

The system may also include a third footwear sensor comparable to the second and first footwear sensor configured to supply a third foot signal reflective of the deflection of the support surface by the player's foot upon application of electrical power to said sensor. Preferably the player's foot has three support points and each of said first footwear sensor, said second footwear sensor and said third footwear sensor are each positioned under one of the three support points.

In some systems, the shaft has a second end opposite said first end. The handle is positioned at the second end; and the handle is configured for grasping with one or both of the hands of a player, in some applications, the handle is deflectable between a first position and a second position upon grasping the handle with one or both of the hands of a player. A handle sensor may be positioned to sense the handle deflection of the handle by one or both of the hands of the player. The handle sensor is configured to change at least one electrical characteristic reflective of said handle deflection and to supply a handle signal reflective of the handle deflection upon application of electrical power to the sensor. The striking processor is configured to receive the handle signal, to process the handle signal into a form for transmission to a remote receiver to transmit the handle signal to the remote receiver for further processing and display.

In some arrangement, the shaft of the striking device is hollow with an interior surface. The striking sensor may be positioned on the interior surface to measure the deflection of the shaft, in some configurations, a second striking sensor may be positioned on the interior surface spaced from the striking sensor. The second striking sensor is also positioned to sense the deflection of the shaft. The second striking sensor is configured to change at least one electrical characteristic reflective of said deflection and to supply a second striking signal to said striker processor reflective of said deflection upon application of electrical power to said sensor. The receiver is configured to receive process and display information reflective of the second deflection signal.

It may be noted that the sport may be golf wherein the shaft is the shaft of a golf club and the striking surface is the face of a golf club head. For golf, the footwear is golf shoes. The sport may also be tennis, badminton, ice hockey, field hockey, squash, cricket, baseball, and even jai alai.

In the drawings, which illustrate what is presently regarded as the preferred embodiments of the disclosed system:

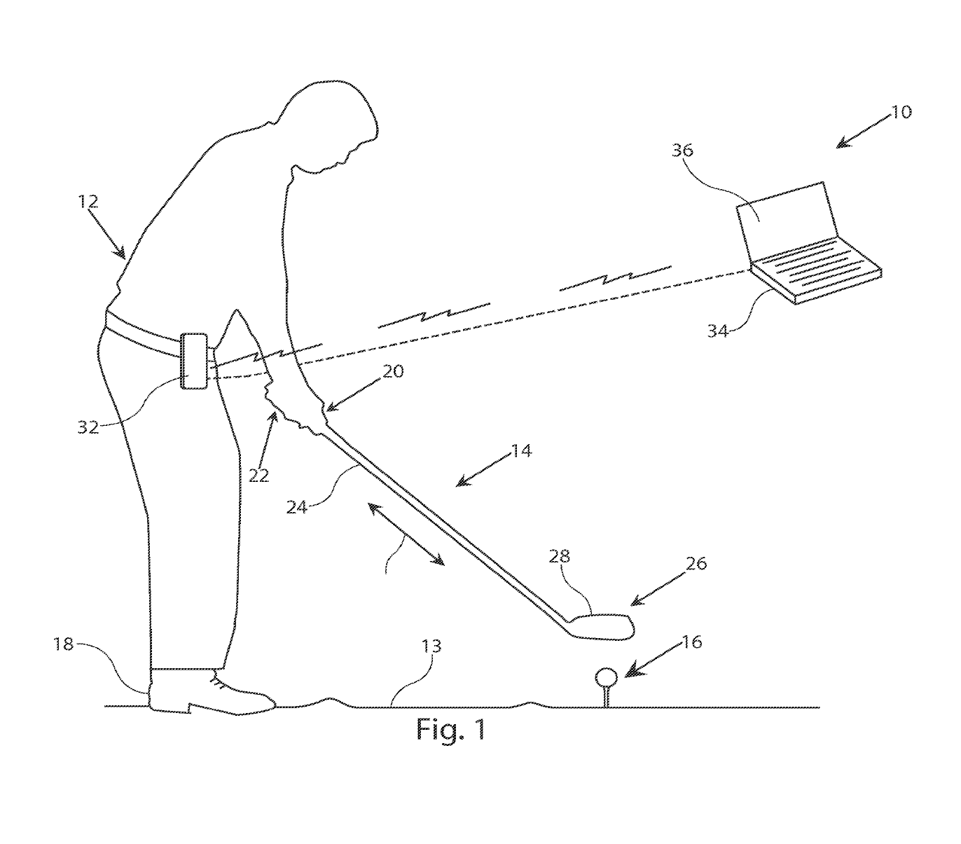

FIG. 1 is a perspective view of a system in use by a player;

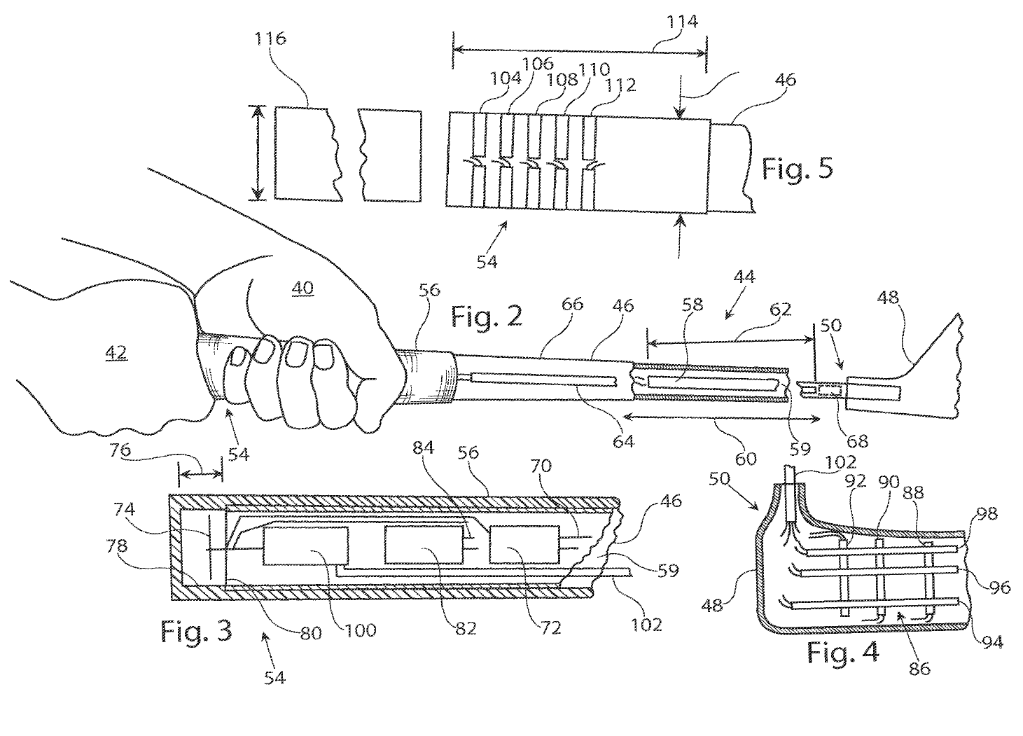

FIG. 2 is a perspective view of a handle on a shaft with a cutaway portion showing a sensor and a striking device;

FIG. 3 is a cross section of the handle on the shaft of FIG. 2;

FIG. 4 is a cross section of a striking device of FIG. 2;

FIG. 5 is an exploded view of the handle on the shaft of FIG. 2;

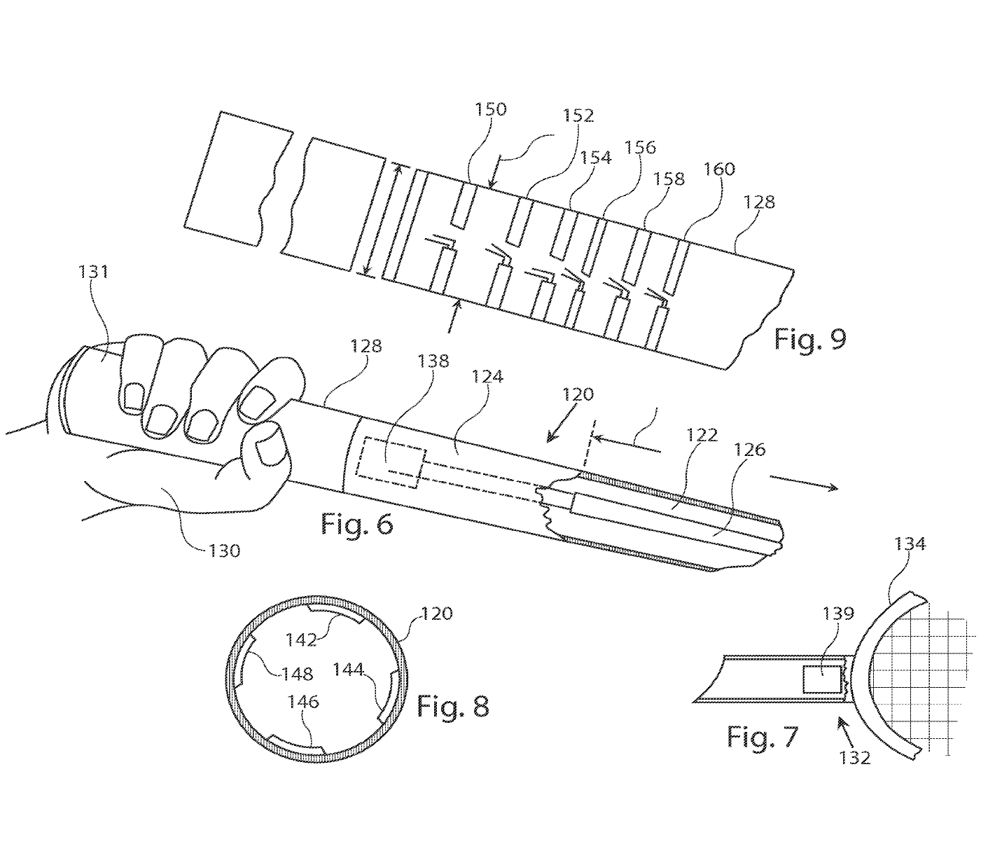

FIG. 6 is a partial cut-away of another form of handle with a shaft;

FIG. 7 is a partial cut-away of another striking device associated with the shaft of FIG. 6;

FIG. 8 is a cross section of the shaft of FIG. 6;

FIG. 9 is an exploded view of the handle of FIG. 6;

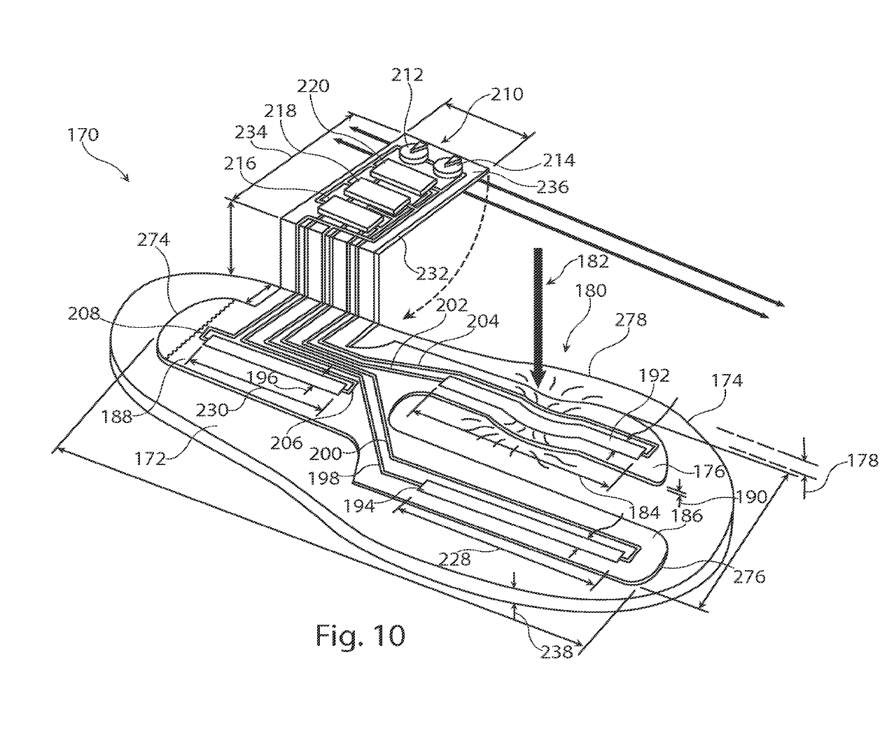

FIG. 10 is a perspective view of a sole used in or with footwear disclosed herein;

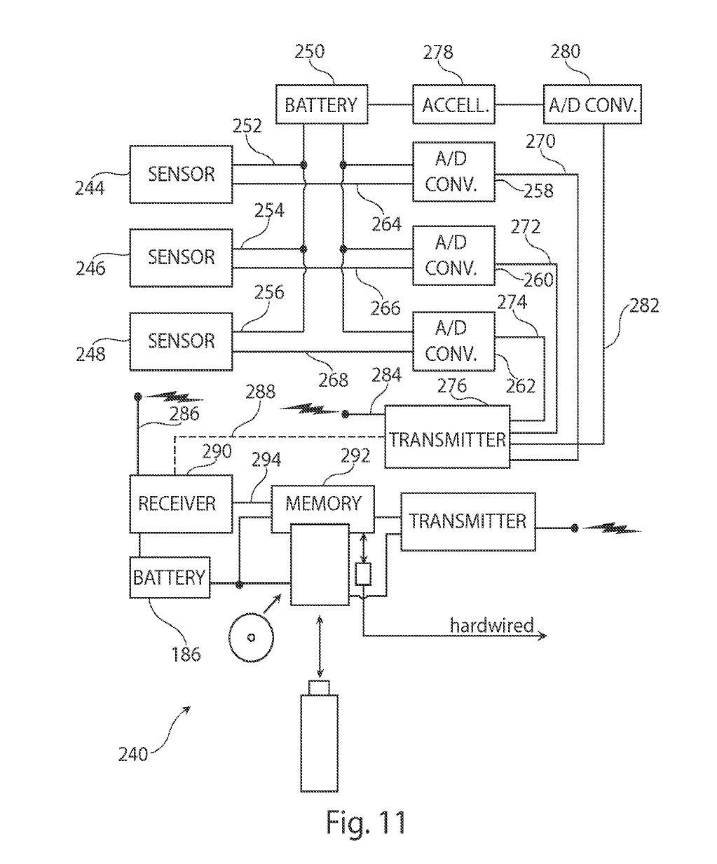

FIG. 11 is a block diagram of selected components of a system as herein disclosed;

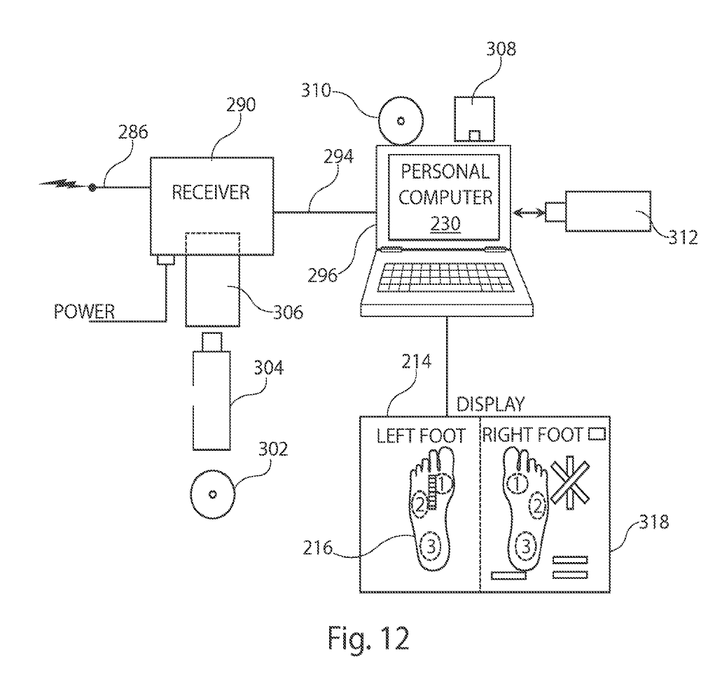

FIG. 12 is also a block diagram of other selected components of a system as herein disclosed with a suggested image to be displayed; and

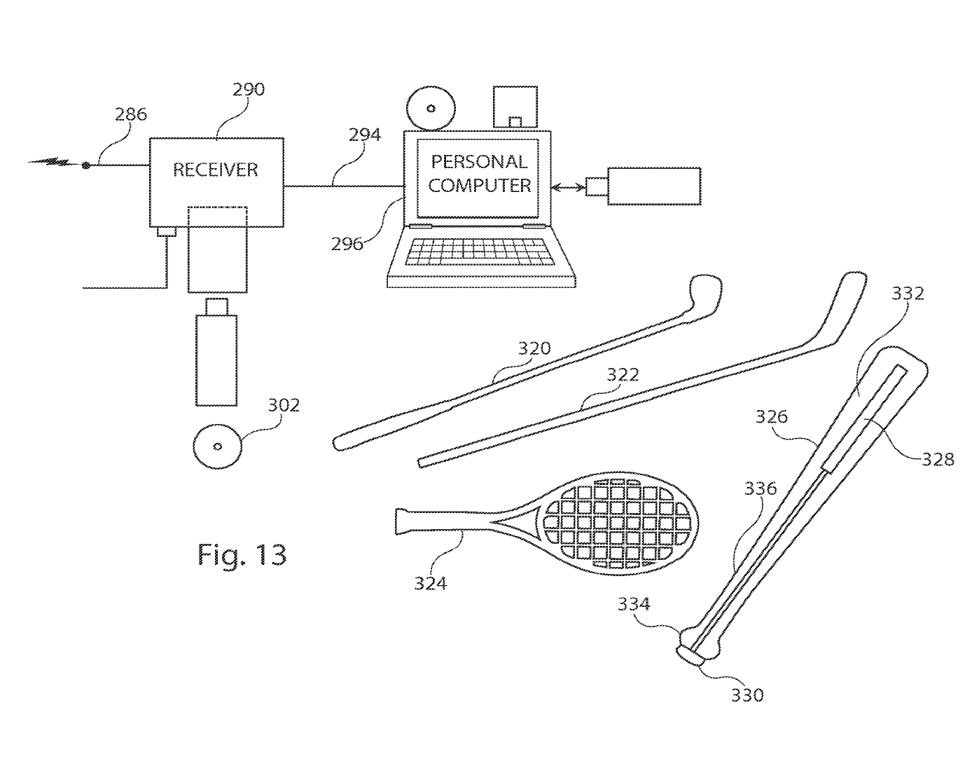

FIG. 13 is also a block diagram of other selected components of a system as herein disclosed along with sample images.

FIG. 1 depicts a system 10 in which a player 12 of a sport (like golf) is shown on a support surface 13 while holding a striking device like golf club 14 which striking device used to strike or hit an object like golf ball 16. The system 10 may include footwear on the player's feet such as golf shoes 18. The striking device 14 is for grasping in at least one hand and as here shown by both hands that are right hand 20 and left hand 22. The striking device has a shaft 24 connected to striking structure like golf club head 26 that has a surface 28 for contacting the object such as the golf ball 16.

The striking device like golf club 14 includes a sensor affixed to the shaft like shaft 24 as hereinafter discussed in detail. The sensor may be any sensor that senses deflection and is configured or can be configured to send a signal reflective of the deflection. Also, an array of force sensitive resistors may be used. The preferred sensor used for the systems herein disclosed are BEND SENSOR® detectors available from Flexpoint Sensor Systems, Inc. of Salt Lake County, Utah and which are disclosed in U.S. Pat. No. 5,583,476 that issued on Dec. 10, 1996. The sensor is of the type that changes at least one electrical characteristic upon deflection. More specifically, a conductive ink is deposited on a substrate. As the substrate deflects the electrical resistance and/or inductance and/or susceptance of the ink changes predictably so that degree or amount of the deflection can be determined.

Thus, in the systems disclosed like the system 10 of FIG. 1, a sensor is positioned on or in the shaft like shaft 24. Thereafter, the shaft is operated by the player (e.g., swung) in a manner to contact the object with a striking surface like surface 28 of the golf club head 26. As the shaft swings, it bends or deflects. The sensor on and along the length of the shaft detects the bending or deflection and sends signals to a striking processor as hereinafter discussed. That is, a source of power is provided in the striking device which power is applied to the sensor. The striking processor thereafter receives the striking signal from the sensor and then processes the signal so that it is sent by a transmitter to a remote receiver.

In a similar fashion, the footwear like golf shoes 18 worn by the player like player 12 is configured with an array of sensors similar to the sensor in the shaft. The sensors are of the type that change at least one electrical characteristic upon deflection when the player is operating the striking device which sensors are positioned in or as part of the footwear. The sensors in the footwear supply a signal reflective of the deflection that occurs as the player stands before operating the striking device and as the player operates the striking device. Signals reflect of the deflection of the feet are sent to a footwear processor that converts the foot signals for transmission to a receiver.

As seen in FIG. 1, a receiver like a cell phone 32 and more particularly a phone using and IOS operating system or an Android® operating system can incorporate an application so that striking signals and footwear signals are processed. and converted to visually perceivable images that a player and/or player may observe on the screen of the phone. It may also present an audio signal. Similarly, the striking signals and footwear signals can be received and processed by a lap top computer like lap top 34 which has been programmed or configured to receive the striking signals and the footwear signals and present images reflective thereof on the screen 36 of the lap top computer 34. It may also present an audio signal. It should be understood that while reference is made here to a cell phone 32 and to a lap top computer 34, other devices including notebooks, Ipads, readers, tablets, tower computers and the like may be used to receive the signals from the processors and present images to the player and/or the player.

Turning now to FIG. 2, the left hand 40 and right hand 42 of a player are shown holding a striking device which is a golf club 44 having a shaft 46 to which is attached a golf club head 48. The shaft 46 has a first end 50 which is attached to the hosel 52 of the golf club head 48. The other end or second end 54 of the shaft 46 has a grip or handle 56 associated or attached thereto sized for gripping with the hands 40 and 42 of the player. The shaft 46 is hollow as shown. A sensor 58 is preferably positioned inside and attached to the inside surface 59 of the hollow shaft 46 which is here shown to be generally circular in cross section tapering from the second end 54 toward the first end 50. The sensor 58 is sized to run along its length 60 of the shaft 46 a distance 62 that is sufficient to detect the deflection of the shaft 46 as it is swung by the player. The length or distance 62 of the sensor 58 may be from about 4 inches to about 35 inches and is preferably from about 8 inches to about 20 inches extending from near the hosel 52 toward the grip or handle 56.

Alternately, a sensor 64 may be attached to the outside surface 66 of the shaft 46 and positioned and sized similar to sensor 58. As the golf club 44 is moved by the player to strike the bail 16, the shaft 46 bends or deflects. The amount of bending or deflection varies with the size and shape of the shaft 46 as well as the materials of construction of the shaft 46 (e.g, metal, fiberglass). The amount of deflection also varies with the speed of the shaft 46 as it is being swung by the player. The sensor 58 (or sensor 64) measures the deflection because the striking processor 72 contains a power supply such as a battery to supply electrical power to the sensor 58 (or sensor 64) the resistance of which varies with deflection as hereinbefore discussed. The sensor 58 (or sensor 64) varies its electrical resistance or other electrical characteristic based on the amount of deflection which is a striking signal.

As better seen in FIG. 3, the sensor 58 is connected by conductors 70 to a striking processor 72 which is configured to receive the striking signal. The sensor 64 is also connected to the striking processor 72 by conductors similar to conductors 70 but not shown. The striking processor 72 is configured to receive the striking signal and to process the striking signal into a form for transmission of a strike signal to a remote receiver like cell phone 32 and/or lap top 34. That is, the strike processor 72 transmits the strike signal to the remote receiver such as the lap top 34 or cell phone 32.

As shown in FIG. 3, the strike processor 72 has an antenna 74 extending from the strike transmitter included in the strike processor 72. The antenna 74 and the transmitter are selected to transmit the strike signal wirelessly through the grip or handle 56. A gap 76 is provided at the second end 54 of the shaft 46 to house the antenna. The inside 78 of the handle 56 may be formed to have a small lip 80 to prevent the handle 56 from being pressed or urged on to the shaft 46 too far. That is, the lip 80 functions to form the gap 78.

An accelerometer 68 is selected to be positioned and attached to the inside surface 59 or the outside surface 66 of the shaft 46 and preferably the inside surface 59. It is selected to be small and lightweight and operates to sense the acceleration of the striking device and more particularly the golf club 44 and the golf club head 48 as it is swung from an at rest position to a position where a striking structure, that is, the golf club head 48 is striking the golf ball 16. The accelerometer 68 sends a signal reflective of the acceleration detected to an acceleration processor. The acceleration processor 82 is connected to the accelerometer by conductors 84 that are not shown extending all the way to the accelerometer 68 for clarity. The acceleration processor 82 is configured to receive the acceleration signal and to process the acceleration signal into a form for transmission of an accelerate signal to a remote receiver like cell phone 32 and/or lap top 34 in same manner as the strike signal. Various accelerometers may be used with a preferred device being configured to sense acceleration in all three axes (i.e., X, Y and Z).

Turning now to FIG. 4, the golf club head 48 is shown in section with an array 86 of sensors. Each sensor 88, 90, 92, 94, 96 and 98 are comparable in form to sensors 58 and 64 because they are of the type that change electrical characteristics upon deflection. The sensor 88-98 in the array 86 are sized and positioned like a grid as shown. As the club head 48 is swung to contact the ball with the surface like surface 28 (FIG. 1), the surface deflects or bends or elastically deforms. The applicable sensors of the array 86 will deflect and send array signals to an array processor 100 via conductors in a conductor bundle 102. Each of the sensors 88-98 has conductors that are combined into the conductor bundle 102. All are not shown for clarity.

It should also be noted that the array 86 can be comprised of more or fewer sensors and be comprised only of horizontal sensors and/or vertical sensors.

In FIG. 5, the grip or handle 56 of the golf club 44 is shown with a plurality of sensors 104, 106, 108, 110 and 112 spaced apart along the length 114 of the grip or handle 56. Each of the sensors are comparable to the sensors 58 and 64. The grip or handle 56 is formed of an elastically deformable material and thus is deflectable where the player grasps and squeezes to hold the handle 56 in the process of swinging the striking device and more particularly the golf club 44 from a rest position to a position where the golf ball is being struck by the golf club head like head 48. The applicable sensors are deflected and send grip signals to the array processor 100 which processes the grip signals and sends them to the receiver just like the processors 82 and 72. A separate non conducting sheath 116 may be slid over the handle 56 and the array 104-112 as a protective cover and as an insulator.

In FIGS. 6 and 7, a striking device is shown which has a shaft 120 of a racket 120 which is one of a tennis racket, a badminton racket, a squash racket and/or a racquetball racket. The shaft 120 is hollow with an inside surface 122 and an outside surface 124. A sensor 126 is comparable to sensors 58 and 64 and is positioned inside the shaft 120 and attached to the inside surface 122 to bend and deflect with the bending or deflecting of the shaft 120 as it is swung by a player gripping the handle 128 with his right hand 130. The sensor 126 has a length 127 that extends from near the first end 132 toward the second end 131 where the length is selected to detect the bending or deflecting of the shaft. The shaft 120 has a first end 132 to which a striking structure is attached like racket face 134. At or near the racket face 134, an accelerometer 136 is positioned to sense the acceleration of the racket and racket face 134 as the player swings the racket to strike the object to be struck which is any appropriate ball. The sensor 126 is connected by conductors 140 to a strike processor 138 which is comparable to strike processor 72 (FIG. 3). The accelerometer 139 is also connected by conductors to an accelerometer processor comparable to accelerometer processor 82 (not shown). The strike processor 72 and accelerometer processor (not shown) all function to transmit signals to a receiver for audio and visual displays reflective of the acceleration and deflection as applicable comparable to the processors hereinbefore discussed.

In FIG. 8, the shaft 120 is shown in cross section with four sensors all comparable to sensor 126 and each connected to a striking processor comparable to strike processor 138 to produce visual and audio signals reflective of deflection on a receiver like the phone 32 or lap top 34.

FIG. 9 shows the grip or handle 128 with a plurality of sensors 150, 152, 154, 156, 158 and 160 positioned about the handle which is also made of elastically deformable material. Thus the player's grip can be detected to monitor not only where the racket is being held but how tight the squeeze or grip of the player. The sensors 150-160 are connected to a grip processor which is comparable to the striking processor and other processors hereinbefore discussed to receive and process signals for audio and visual presentation on the receiver.

Turning now to the footwear, FIG. 10 shows a sample insert 170 of the type that is used in shoes or footwear like golf shoes 18 (FIG. 1). It may also reflect a sole or insole of any form of footwear used by a player. Further, it should be understood that the principles of construction and operation of the insert 170 apply to both feet even though FIG. 2 shows the bottom 172 only for use with the left foot of a player. The right foot has not been illustrated for simplicity.

The insert 170 of FIG. 10 has a substrate or base 174 that is made of an electrically insulating material. At the same time, it is durable and long wearing while being flexible and elastically deformable. Various polymers such as polyimide, polycarbonate and polyesters are believed to be particularly suitable. For example, E.I. duPONT and de NEMOURS & Co. of Wilmington Del. (DuPont) offers Kapton® film (a polyimide) and Mylar® film (a polyester). Both are believed to be suitable for use.

The base 174 is flexible or elastically deformable much like a piece of paper. That is, the base 174 may be bent or twisted or deflected upon application of a suitable force. As shown in FIG. 10, the outer element 176 of the base 174 is moved downwardly 178 a distance which is the deflection by force 182 to form detent 180. Thus, the outer element 176 moves from its normal position to a deflected position haying length 184 as the detent 180 is formed by the force 182.

The insert 170 of FIG. 10 has an outer element 176 and an inner element 186 both of which are connected like the heel element 188. While the base 174 is preferably unitarily formed, it may be formed in segments or parts. For example, one or both of the outer element 176 and the inner element 186 both may be separate and be joined to the heel element 188 by suitable means such as a piece of thin tape. Of course, different pieces of the base 174 also could be joined together using suitable plastic welding procedures.

The base 174 of the insert 170 has a thickness 190 that is substantially uniform. However, the thickness 190 for the heel element 36 may be different from the thickness 190 of the base 174 proximate the outer element 176 and the inner element 186. The thickness 190 for the base 174 as shown may be from about 0.1 inch to about 0.01 of an inch. A relatively small thickness 32 is preferred for most applications in which the footwear encloses or surrounds the foot of a player like a typical shoe or boot as seen generally in FIG. 1.

The insert 170 of FIG. 10 the outer element 176 includes a sensor 192; the inner element 186 has a sensor 194; and the heel element 188 has a sensor 196. All three sensors are comparable to the sensors like sensors 142-160. While three sensors 192, 194 and 196 are contemplated for footwear, it should be understood that one sensor may be sufficient. Of course, in other applications more than three sensors may be suitable.

The outer sensor 192 is positioned on the outer element 174. The inner sensor is positioned on the inner element 186; and the heel sensor 42 is positioned on the heel element 188. The sensors, like sensor 192, 194 and 196 can be obtained from Flexpoint Sensor Systems, 106 West 12200 South, Draper, Utah 84020.

By applying a voltage or a current to any one and all of the outer sensors 192, 194 and 196, a corresponding change in the current or voltage can be detected that reflects the total amount of the deflection 178 of the outer sensor 192 and comparable deflection of the ball or inner sensor 194 and the heel sensor 196. In turn, power is supplied via conductors 198, 200, 202, 204, 206 and 208 from a power supply 210 made up of two batteries 212 and 214 wired in series. Similar batteries may be used with the striking devices described hereinbefore.

The deflection signals reflective of deflection 178 of outer sensor 192 and similar deflection signals of the inner sensor 194 and the heel sensor 196 are changes in electrical current passing through the sensors and supplied to the foot processors 216, 218 and 220. The foot processors thus receive an analog electrical signal which is converted into digital deflection signals. The foot processors 216, 218, and 220 depicted are analog to digital converters which are preferably a 10 bit device that operates between 10 and 1000 Hz.

In FIG. 10, the foot base 174 is shown to have three areas of support, namely the heel area 274, the ball area (behind the big toe) 276 and the outside area (behind the little toe) 278. When upright, the player is applying a force to the support surface through each of the three areas of support on both feet. Thus, if one knew how much support or force was being applied through each area for each foot, it could suggest and, in some cases, establish if a player was properly distributing the player's weight between the players two feet and, if not, which foot was supporting more than the other. If one knew how much support or force was being applied through the different areas of each foot, the resulting pattern could suggest, and in some cases establish, that the weight on that foot was being improperly distributed to one or two areas rather than traditional or typical weight distribution between the three areas. A suitably qualified person could then take steps to cause inserts for a player's shoe to redistribute the weight between feet and even areas of support in each foot. Also, exercises could be adopted to strengthen muscles to effect more even distribution of the player's weight on each foot and between feet.

The amount of support at each of the heel are a274, the ball area 276 and the outside area 278 may vary not only when standing statically but also when the player is swinging a striking device. Information about the support or force experienced at each of the support points when swinging can be useful to determine how the player is moving in relation to some standard for comparison. With the information, steps can bet taken to help develop, for example, either a training program or some prosthesis (e.g., shoe insert) to help.

In FIG. 10, it can be seen that the outer sensor 192, the inner sensor 194 and the heel sensor 196 are each shown to have a length 184, 228 and 230 respectively selected to extend through or substantially through the outer area 176, the ball area 186 and the heel area 188 of the base 174. The outer sensor 192, the inner sensor 194 and the heel sensor 196 may optionally be oriented to extend transverse to or normal to their present orientation or in other words, the present orientation of the sensors along the length 26 of the base 18 is preferred but may extend in any desired orientation with each sensor in a different orientation relative to each other.

It may also be noted that the outer sensor 192, the inner sensor 194 and the heel sensor 196 each are essentially straight. However, other shapes or forms may be used. Further, the width of the sensors can vary together and separately.

In FIG. 10, the base 174 has a side member 232 that extends outwardly a distance 234 selected to position the support surface 236 away from the base 174 so that the support surface 236 may be or extend over the side of a shoe or be a sandal strap. Alternately, the support surface can be positioned under the base 176 proximate the arch of the foot. The support surface 236 has affixed thereto the foot processors 216, 218 and 220 along with the power supply 210 and an accelerometer and a transmitter. An ADXL 2 axis accelerometer offered by Analog Devices Inc. of Norwood, Mass. 02062 is one possible device that could be used.

The base in FIG. 10 is configured to be essentially the same as an insole that is typically positioned inside of shoes. It has a thickness that may be about ⅛ of an inch and is often made of a resilient rubber-like or neoprene-like material. It is often selected so that it allows moisture to pass there through (“breathes”) while providing suitable cushion comfort for the player. An insole 116 is typically sized to fit into a shoe or similar item of footwear.

The block diagrams of FIGS. 11 and 12 depict a suitable sensing system 240 and 242 that has a plurality of sensors such as sensors 244, 246 and 248. Three sensors 244, 246 and 248 are depicted one for positioning at the ball area, the outside area and the heel area of the foot as discussed in connection with FIG. 10. Additional sensors can be used in other areas of the foot. Other configurations or patterns of sensors may be used as desired with the preferred sensors being of the type that predictably change resistance upon mechanical deflection such as the BEND SENSOR® detectors offered by Flexpoint Sensor Systems, Inc. of Draper, Utah.

The sensors 244, 246 and 248 are each connected to a power supply such as battery 250 via conductors 252, 254 and 256. The sensors 244, 246 and 248 also are connected to analog to digital converters (A/D converters) 258, 260 and 262 via conductors 264, 266 and 268. The battery 250 supplies power to the sensors 244, 246 and 248 which are electrical resistors that vary in resistance as they are deflected. In turn, the electrical current in the conductors 252, 254 and 256 going to processors 258, 260 and 262 varies with the deflection. The current is in effect an analog signal that the A/D converters convert to digital signals that are supplied via conductors 270, 272 and 274 to a transmitter 276 that processes the digital signals and transmits them as a radio frequency (RF) signal. The transmitter 276 may supply an amplitude modulated signal or carrier and pulse or frequency modulated signal or it may process in any other suitable way. The digital converters preferred have a sample frequency of about 10 Hertz and an output that is supplied at a frequency that may vary from about 10 to 1000 samples or transmissions per second. In some cases, an RFID chip can be adapted as the transmitter. In a preferred application an ASIC has been prepared that includes a ARM® Cortex CPU that operates up to 48 MHZ along with a 32 KM flash memory and a 4 Kb SRAM The ASIC also includes a programmable 12 bit 1 MSPS SAR Op-Amp with four PLD based logic blocks. The battery 250 may be replaced with a rechargeable device suitably configured to be charged by magnetic induction.

FIG. 11 also shows an accelerometer 278 that is positioned on or about the foot. It could be located on the footwear, on a sock or on the lower leg. The accelerometer 278 is a typical 3 axis device while other single or two axis options may be used as desired. A three axis device is used to measure the forward movement in three dimensional space of the wearer. Thus, it could be used to measure performance moving sideways or diagonally. A single axis device could measure movement in a forward/reverse direction only. The accelerometer supplies analog signals reflective of acceleration to an A/D converter 280 via conductor 282. The A/D converter 280 supplies digital signals reflective of acceleration in the X, Y and Z axis via conductor 282 to the transmitter 276 for processing and transmission as an RF signal. Notably, the A/D converter and transmitter can be viewed as a processor that receives incoming signals in analog form and transmits RF signals reflective of the incoming signals.

In FIG. 11, it can be seen that the RF signal with the digital signals from the AD converters is transmitted as a low energy signal from a transmitting antenna 284 to a receiving antenna 220 that is positioned within sufficient range to receive the signal and connected to a receiver 290 which is configured to receive and separate out the transmitted signals. Alternately, the RF signal may be transmitted via a suitable RF cable 288 that is sized to extend between the transmitter 276 and the receiver 290 with sufficient length to allow full movement of the player.

In preferred applications, the receiver 228 of FIG. 11 is positioned in a chassis. It receives the RF signals and processes them to extract the digital signals reflective of deflection of each of the sensors 172, 174 and 176 as well as digital signals reflective of the acceleration in up to three axes, the X axis, the Y axis and the Z axis and any other digitally transmitted signals. The digital signals are supplied to the memory 292 via conductors 294 for storage until they are delivered to a computer like processor found in a cell phone or in a lap top computer for further processing, in other words, the receiver may be a device configured to receive RF signals such as WIFI and thereafter include a processor which has the software or an “application” configured to produce audio and visible images including video of that which has been sensed. The digital signals may be delivered to the cell phone 32 (FIG. 1) carried by the player or a coach nearby. The cell phone has a screen to present images perceivable depicting what has been sensed. In the case of footwear, it shows the users feet as seen in FIG. 12.

Alternately, the digital signals can be sent to the memory 292 of a lap top computer 296, or sent to other storage such as a disc 302 or a flash drive 304 or even a sim chip 306 as seen in FIG. 12. The digital signals may be delivered to the lap top 296 wirelessly, by sim chip 308, disc 310 or flash drive 312 or by any other means know to those in the art.

The cell phone 32 and the lap top 296 are both programmed or configured to process the digital signals and produce signals to present an audio signal and visually perceivable display such as the display seen in FIG. 12. The display may be an image of a left foot 316 and a right foot 318 that has the areas depicted like areas 1, 2 and 3 where sensors have been placed by use of an insert like insert seen in FIG. 10. The display 244 may be configured to produce an image that is changing as the player swings the striking device. In a more preferred arrangement the transmitter 276 supplied the digital signals in a WiFi format which may be received by the cell phone 32 and a lap top 296 configured to receive WiFi signals.

In use, a player may record all the digital signals connected to his use of a striking device during a particular period or event either in the PC 230 or in the cell phone 32. The digital signals may be compared to or with the data from an earlier or later period or event to show change or progress. This, in turn, may be used to suggest how the player may better move his or her feet to enhance his or her performance in connection with the sport and use of the striking device.

Referring now to FIG. 13, a portion of a system is depicted to show the receiving. Digital signals from any one or more of the processors 138 (FIG. 6) and processors 72, 82 and 100 (FIG. 3), or any other processors receiving signals from a sensor that are converted to a digitally transmitted signal arrive at the receiver 290 via antenna 286 and are delivered to storage devices such as a disc 302, flash drive 304 and/or sim chip 306 for further transmission and use with compatible machines and. devices. Alternately and preferably the digital signals are sent to lap top 296 or to a suitably equipped cell phone 32 both configured to present images reflective of the digital signals. Thus, a golf club 320 is shown that can be produced on the screen with other indicia to show deflection or bending and when so configured as seen in FIGS. 4 and 5, the impact position on the club face and the position and force of the grip on the handle. A hockey stick 322 is also shown as it too may be depicted to show deflection of the shaft and the position and force of the grip as well as the impact position when the puck is contacted. The racket 324 may be similarly configured as seen in FIGS. 6, 7 and 9 with the racket being depicted on the screen of the PC or cell phone. A baseball bat 326 is also shown. Wooden bats may have a sensor 328 along the striking portion 332 with the processor, battery and other components on the end 330. Metal bats are hollow and may have a sensor mounted in the interior along with the processor and other related components with an antenna at or near the end 334 of the handle portion 336. In all cases bar graphs, pie charts, or light bars may be used to depict relative changes or values or even absolute values. Similarly, an audio signal may include voice statement triggered by reaching certain levels or sounds changing in amplitude and or frequency to reflect sensed data.

It should be noted that the signals from a sensor of the type that varies electrical characteristics will be analog so that the processor structure will involve an A/D converter along with means to form the digital signal into a suitable transmittable signal. The transmittable signal will preferably be of such a type that a cell phone suitably configured and a lap top suitably configured can receive those signals and process them to present the described and desired visually perceivable images which are typically dynamic displays.

It should also be understood that in use, the player may wear suitable shoes or other footwear configured to supply data about the user's footwork and body management. At the same time, a striking device is configured to sense its operation by sensing its deflection and possibly or desirably information about where the striking surface impacts the object to be struck and the use of the player's hands simultaneously or sequentially or separately.

Those skilled in the art will recognize that many changes or variations may be made to the above illustrated system and the components thereof without departing from the spirit of the invention. Therefore, the details of the embodiment or alternatives illustrated and/or described are not intended to limit the scope of the appended claims.

I claim:

1. A system for a player of a sport,
said system comprising:
a striking device configured for grasping by the player, said striking device including
a shaft
having a length with a striking structure affixed at a first end of said shaft and means for grasping said shaft at a second end of said shaft opposite said first end, said striking structure being configured for striking an object, and said shaft deflecting as it is moved by the player from a first orientation to a second orientation in which the striking structure is striking the object;
a first striking sensor attached to said shaft and positioned to sense said deflection, said first
striking sensor being configured to change at least one electrical characteristic reflective of said deflection and to supply a first striking signal reflective of said deflection upon application of electrical power to said sensor;
a striking processor configured to receive said first striking signal, to process said first striking
signal into a form for transmission to a remote receiver and a striking transmitter for transmitting a first strike signal reflective of said striking signal to a remote receiver;
footwear configured for the sport and sized to fit on the foot of the player, said footwear having a support surface upon which the foot of the player is positioned to support at least part of the weight of a player and deflect upon movement of said player's foot while striking said object;
a first footwear sensor positioned in and proximate said support surface to sense the deflection of said support surface by the player's foot, said first footwear sensor being configured to change at least one electrical characteristic reflective of said deflection and to supply a first foot signal reflective of the deflection of said support surface by the player's foot upon application of electrical power to said sensor;
a footwear processor configured to receive said first foot signal, to process said first foot
signal into a form for transmission to a remote receiver and a footwear transmitter for transmitting foot signals reflective of said first foot deflection signal to a remote receiver; and
a receiver positioned remote from said footwear transmitter and said striking processor and
configured to receive said foot signals and said strike signals and to form a visually perceivable image of the foot deflection signal and of the striking

2. The system of claim 1 further including an accelerometer positioned proximate to said one end of said shaft, said accelerometer being connected to said striking processor and configured to supply acceleration signals reflective of the acceleration of said striking device to said striking processor during movement of said shaft from said first orientation to said second orientation and wherein said striking processor is configured to receive said acceleration signals and process them into a form for transmission to said receiver by said striking transmitter, and wherein said receiver is configured to receive said acceleration signals from said striking transmitter and process them to present a visually perceivable image of the acceleration signal.

3. The system of claim 1 further including a second footwear sensor positioned in and proximate to said support surface and spaced from said first footwear sensor to sense the deflection of said support surface by the player's foot, said second footwear sensor being configured to change at least one electrical characteristic reflective of said deflection and to supply a second foot signal reflective of the deflection of said support surface by the player's foot upon application of electrical power to said sensor, wherein said footwear processor is configured to receive said second foot signal and to process said second foot signal into a form for transmission to a remote receiver by said footwear transmitter and wherein said receiver is configured to receive said second foot signal and to display a visually perceivable image of said second foot signal.

4. The system of claim 3 further including a third footwear sensor positioned in and proximate to said support surface and spaced from said first and second footwear sensor to sense the deflection of said support surface by the player's foot, said third footwear sensor being configured to change at least one electrical characteristic reflective of said deflection and to supply a third foot signal to said footwear processor reflective of the deflection of said support surface by the player's foot upon application of electrical power to said sensor, said footwear processor being configured to receive said third foot signal and to process said third foot signal into a form for transmission to said receiver by said foot wear transmitter, and wherein said receiver is configured to receive said third foot signal and to display a visually perceivable image of said third foot signal.

5. The system of claim 4 wherein said player's foot has three support points and wherein each of said first footwear sensor, said second footwear sensor and said third footwear sensor are each positioned under one of said three support points.

6. The system of claim 1 wherein said shaft has a second end opposite said first end, wherein a handle is positioned at said second end and wherein said handle is configured for grasping by one or both of the hands of the player.

7. The system of claim 6 wherein said handle is deflectable between a first position and a second position upon grasping the handle with one or both of the hands of a player, and wherein a handle sensor is positioned to sense the handle deflection of the handle by one or both of the hands of the player, wherein said handle sensor is configured to change at least one electrical characteristic reflective of said handle deflection and to supply a handle signal reflective of the handle upon application of electrical power to said sensor and wherein said striking processor is configured to receive said handle signal, to process said handle signal into a form for transmission to a remote receiver and a striking transmitter for transmitting said handle signal to a remote receiver.

8. The system of claim 1 wherein said shaft is hollow with an interior surface and wherein said first striking sensor is positioned on the interior surface.

9. The system of claim 8 further including a second striking sensor positioned on said interior surface spaced from said first striking sensor, wherein said second striking sensor is positioned to sense said deflection, said wherein said second striking sensor is configured to change at least one electrical characteristic reflective of said deflection and to supply a second striking signal to said striker processor reflective of said deflection upon application of electrical power to said sensor, and wherein said second striking sensor is connected to said striking processor, and wherein said striking processor is configured to receive said second striking signal, to process said second striking signal into a second strike signal for transmission to said receiver by said striking transmitter, and wherein said receiver is configured to receive said second strike signal and process said second strike signal and present a visually perceivable image of second strike signal.

10. The system of claim 8 wherein said striking structure has a striking face with an outer surface and an inner surface, and wherein said striking face deflects upon contact with the object, and wherein the inner surface has an array of sensors to detect the location of the contact with the face deflection and which sensors send face deflection signals to a face processor, and wherein said face processor is configured to receive said face deflection signals and process said face deflection signals into a face signal for transmission to the remote receiver and a face transmitter for transmitting said face signals to said receiver, and wherein said receiver is configured to receive said face signals and process said face signals to form a visually perceivable image reflective of said face signals.

11. The system of claim 6 wherein said handle is formed of a material that is elastically deformable upon grasping by the player, wherein an array of handle sensors are positioned about the handle to detect the location of the contact by the players hand or hands and the amount of deformation which sensors send handle grasping signals to a handle processor, and wherein said handle processor is configured to receive said handle grasping signals and process said handle grasping signals into handle signals for transmission to the remote receiver and a handle transmitter for transmitting said handle signals to said receiver, and wherein said receiver is configured to receive said handle signals and process said handle signals to form a visually perceivable image reflective of said handle signals.

12. The system of claim 1 wherein said sport is golf, wherein said shaft is the shaft of a golf club, wherein the striking surface is a golf club head, and wherein said footwear is golf shoes.

13. The system of claim 1 wherein said sport is tennis, wherein said shaft is the extension of a tennis racket between the handle and the striking surface, wherein said striking surface is a tennis racket head and wherein said footwear is tennis shoes.

14. The system of claim 1 wherein said sport is hockey wherein said shaft is the length of a hockey stick between the handle and the blade, wherein the striking surface is the blade of the hockey stick, and wherein the footwear is one of hockey skates and field hockey shoes.

15. The system of claim 1 wherein said sport is squash, wherein said shaft is the extension of a squash racket between the handle and the striking surface, wherein said striking surface is a squash racket head and wherein said footwear are athletic shoes.

16. The system of claim 1 wherein the sport is jai alai and wherein the striking device is a cesta that is woven and attaches to the arm of the player and extends from the arm toward a tip, wherein the striking surface is the interior of the cesta, wherein the footwear are athletic shoes preferred for playing jai alai.

17. A system for a player of a sport in which an object is struck with a striking structure,
said system comprising:
a striking device configured for grasping by the player, said striking device including
a shaft
having a length with a striking structure affixed at one end of said shaft, said striking structure being configured for striking the object, said shaft being configured for deflection from a first orientation to a second orientation upon movement to strike the object and to deflect upon striking the object from a first shaft configuration to a second shaft configuration, said shaft being essentially hollow having at least one interior surface and at least one exterior surface;
at least one striking sensor positioned on one of said exterior surface and said interior surface of said shaft to detect said deflection of said shaft said striking sensor being configured to change at least one electrical characteristic reflective of said deflection and to supply a striking signal reflective of the deflection upon application of electrical power to said sensor;
a striking transmitter configured to receive said striking signal, to process said striking signal
into a form for transmission to a remote receiver and a striking transmitter for transmitting said striking signal to a remote receiver;
footwear for positioning configured for the sport and sized to lit on the feet of the player, said
footwear having a support surface upon which the feet of the player are positioned to support at least part of the weight of a player and deflect upon movement of said player's feet while striking said object;
an array of footwear sensors positioned in and proximate said support surface to sense the
deflection of said support surface, said array of footwear sensors each being configured to change at least one electrical characteristic reflective of said deflection and to supply foot signals reflective of the deflection of said support surface upon application of electrical power to said sensor;
a footwear transmitter configured to receive said foot signals, to process said foot signals into a form for transmission to a remote receiver and a footwear transmitter means for transmitting said foot signals to a remote receiver; and
a receiver positioned remote from said footwear transmitter and said striking transmitter and
configured to receive said foot signals and said striking signal and to form a visual image of the foot deflection signal and of the striking signal.

18. The system of claim 17 wherein said receiver is a smart phone with an application configured to process said foot signals and said striking signal and to form said visual image.

19. The system of claim 17 wherein said receiver is a lap top computer programmed to process said foot signals and said striking signal and to form said visual image.

20. A system for measuring operation by a user, said system comprising:
a striking device configured for grasping by a user, said striking device including a shaft
having a length with a striking structure affixed at a first end of said shaft and means for grasping said shaft at a second end of said shaft opposite said first end, said striking structure being configured for striking an object, and said shaft deflecting as it is moved by the user from a first orientation toward a second orientation between which the striking structure impacts the object;
a striking sensor attached to said shaft and positioned to sense said deflection of said shaft,
said striking sensor being configured to change at least one electrical characteristic reflective of said deflection and to supply a first striking signal reflective of said deflection upon application of electrical power to said sensor;
a striking processor configured to receive said striking signal, to process said striking signal into a form for transmission to a remote receiver and a striking transmitter for transmitting a strike signal reflective of said striking signal to a remote receiver:
footwear sized to fit on the foot of the user, said footwear having a support surface upon
which the foot of the user is positioned to support at least part of the weight of the user and deflect upon movement of said user's foot while striking said object;
a footwear sensor positioned in and proximate said support surface to sense the deflection of said support surface by the user's foot, said footwear sensor being configured to change at least one electrical characteristic reflective of said deflection and to supply a foot signal reflective of the deflection of said support surface by the user's foot upon application of electrical power to said sensor;
a processor configured to receive said foot signal, to process said foot signal into a form for
transmission to a remote receiver and a footwear transmitter for transmitting foot signals
reflective of said foot deflection signal to a remote receiver; and a receiver positioned remote from said footwear transmitter and said striking processor and configured to receive said foot signal and said strike signal and to form a visually perceivable image of the foot deflection signal and of the striking
